(19) United States
(12) Patent Application Publication
(10) Pub. No.: US 2024/0109102 A1
(43) Pub. Date: Apr. 4, 2024

(54) Method and Apparatus for Sorting Flowable Solid Material

(71) Applicant: Sorterra Pty Ltd, Brisbane (AU)

(72) Inventors: Adam Stewart, Brisbane (AU); Troy Blagden, Brisbane (AU)

(73) Assignee: Sorterra Pty Ltd, Brisbane, QL (AU)

(21) Appl. No.: 18/276,423

(22) PCT Filed: Nov. 30, 2021
(86) PCT No.: PCT/AU2021/051426

§ 371 Date: Aug. 8, 2023

(30) Foreign Application Priority Data
Dec. 1, 2020 (AU) 2020904455

(51) Int. Cl. B07B 13/04; B07B 13/16

(52) U.S. Cl. CPC B07B 13/04; B07B 13/16

(57) ABSTRACT

Sorting apparatus for sorting of bulk material comprising flowable particles, the apparatus comprising: a material feeding chamber for receiving and/or holding bulk material; a feeding aperture positioned relative to the chamber for allowing material particles to flow out of the material feeding chamber under gravity; a slanted receiving surface positioned below the feeding chamber and spaced away from an edge portion of the feeding aperture to receive the material particles flowing out from the feeding aperture; wherein a gap between the edge portion of the feeding aperture and the slanted surface is at least equal to the average particle size of the flowable material particles being sorted.

### TECHNICAL FIELD

The present invention relates to sorting apparatus and methods for sorting flowable solids. This invention has particular, but not exclusive application to sorting apparatus and methods for sorting bulk materials such as coal and produce, and for illustrative purposes reference will be made to such application. However, it is to be understood that this invention could be used in other applications, such as interdiction in particulate streams generally.

### BACKGROUND

Any references to methods, apparatus or documents of the prior art are not to be taken as constituting any evidence or admission that they formed, or form part of the common general knowledge.

There exists a well-developed art of sorting materials in a flow by diverting the flow into a substantial monolayer, passing the monolayer past a sensor array to identify particles in the flow, and acting on that identification to process the flow. The processing may involve extracting or ejecting identified particles from the flow, or actively modifying the identified particles.

Sorting applications by nature require a feed of material, of controlled capacity and, of uniform spread past the sensor array of the sorter apparatus. Yet most bulk particulate material feeds are typically formed as fluctuating condensed bulk material flow.

Currently known methods and apparatus involve subjecting the concentrated bulk material to substantially horizontal vibrations or by using an oscillating edge bounded plate of known width of spread, and a known length to said bounded edge. The current methods involve allowing bulk material flow to spread while gradually traversing the length of the plate to pass the bounded edge with a substantially monolayer uniform spread. This prior art is well adopted for feeding bulk particulate sorting apparatus. However, there are several shortcomings associated with such prior art.

The prior art methods do not allow precise control of the output feed because of the method's innate inability to control or minimize delays cause by the time required by the particles to transverse the length of the vibrating plate. The prior art methods also have a limited range of operational capacity. Low flow input rate may not produce a uniform flow and higher input flows may induce flow inconsistencies and blockages. Another issue relates to the vibration or oscillation induced upon the vibrating plate which produces inconsistencies or waves during the spreading process. The prior art is replete with methods and knowhow for reducing and minimising the impact of the vibrating plate upon sorting applications.

In view of the above, it is desirable to provide a method and apparatus for sorting flowable solid material that addresses some of the shortcomings of the prior art.

### SUMMARY OF INVENTION

In an aspect, the invention provides a controlled feeding apparatus for preferred presentation of bulk material comprising flowable particles, for preferably sorting apparatus. The controlled feeding apparatus comprising:
a material feeding chamber for receiving and/or holding bulk material;
a feeding aperture positioned relative to the chamber for allowing material particles to flow out of the material feeding chamber under gravity;
a slanted receiving surface positioned below the feeding chamber and spaced away from an edge portion of the feeding aperture to receive the material particles flowing out from the feeding aperture;
   wherein a gap between the edge portion of the feeding aperture and the slanted surface is at least equal to the average particle size of the flowable material particles being sorted.

In another aspect, the invention provides a method for controlled feeding and presentation of bulk material comprising flowable particles, the method comprising:
directing said bulk flowable material into a feeding chamber positioned for receiving and/or holding bulk material;
positioning a feeding aperture relative to the chamber to allow material particles to flow out of the feeding aperture under gravity onto a slanted receiving surface positioned below the feeding chamber and spaced away from an edge portion of the feeding aperture by maintaining a gap between the edge portion of the feeding aperture and the slanted surface such that the gap is at least equal to the largest particle size of the flowable material particles being sorted.

In an embodiment, the controlled feeding apparatus further comprises: a spacing arrangement for controlling a size of the gap between the edge portion of the feeding aperture and the slanted surface.

In an embodiment, the slanted receiving surface and/or the feeding aperture are movably mounted for controlling a size of the gap between the edge portion of the feeding aperture and the slanted surface.

In an embodiment, the feeding aperture is positioned along an edge portion of one or more internal walls defining the material feeding chamber.

In an embodiment, the material feeding chamber comprises a hollow frusto-conical chamber extending between a first end and a second end with an internal space therebetween for receiving the bulk material presented to be sorted.

In an embodiment, the feeding aperture is positioned at one of said first or second ends.

In an embodiment, the sorting apparatus further comprises one or more convergent internal walls defining the hollow internal space space wherein the convergent internal wall converges in a direction from the first end to the second end and wherein the feeding aperture is located at or adjacent the second end.

In an embodiment, the sorting apparatus further comprises a substantially conical or frusto-conical receiving body having said slanted receiving surface.

In an embodiment, the convergent upper portion of the conical or frusto-conical receiving body is received into the feeding aperture such that the gap between the edge portion of the feeding aperture and the slanted surface of the conical or frusto-conical receiving body is at least equal to the largest particle size of the flowable material particles being sorted.

In an embodiment, during use, the edge portion of the aperture is spaced away from the slanted surface of the receiving body to define an annular gap therebetween for controlling the flow of the material particles flowing out of the aperture under gravity.

In an embodiment, separation between the slanted receiving surface and the edge portion of the aperture is substantially uniform along the entire length of the annular gap.

In another embodiment, separation between the slanted surface and the edge portion of the aperture is substantially non-uniform along the entire length of the annular gap.

In an embodiment, the sorting apparatus further comprises a first positioning arrangement to position and retain the chamber and the conical or frusto-conical receiving body coaxially relative to each other.

In an embodiment, the sorting apparatus further comprises a second positioning arrangement to position and retain the chamber and the conical or frusto-conical receiving body in a non-coaxial configuration relative to each other.

In an embodiment, the apex angle of the receiving body is greater than apex angle of the frusto-conical chamber.

In an embodiment, the slanted surface is formed by collecting material particles on a substantially flat collecting surface to form a pile, the slanted surface being formed by the collected particles of the pile at an angle of repose to an edge portion of the collecting surface thereby forming a slanted particle surface at the angle of repose positioned to form the gap with the edge portion defining the aperture of the chamber and wherein the slanted particle surface receives and diverts the material particles flowing out from the feeding aperture to form a monolayer of said material particles upon passing the collecting surface bounded edge.

In an embodiment, the collecting surface may extend horizontally relative to the aperture.

In an embodiment, the size of the feed aperture is variable and wherein the apparatus further comprises a controller for controlling size of the feed aperture is variable

In an embodiment, the feed aperture is movably mounted for varying the size of the gap between the edge of the aperture and the slanted surface.

In an embodiment, the feed aperture is movable in an upward or downward vertical direction relative to the slanted surface to vary the size of the gap between the edge of the aperture and the slanted surface.

In an embodiment, the sorting apparatus further comprises deflecting members positioned at or adjacent said apertures for deflecting material particles onto the slanted surface.

In an embodiment, the sorting apparatus further comprises an additional receiving surface positioned below the slanting surface to receive and accumulate sorted material particles that have passed through the gap and flowed along the slanting surface.

Preferably, the additional receiving surface is positioned below the slanting surface in a spaced apart relationship for allowing sorted particles flowing along the slanting surface to fall onto the additional receiving surface under gravity.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a sectional view of sorting apparatus 100 in a first operating configuration accordance with a first embodiment.

FIG. 2 is a sectional view of the sorting apparatus 100 in a second operating configuration.

FIG. 3 is a sectional view of the sorting apparatus 100 in a third operating configuration.

FIGS. 4A to 4C illustrate sectional view of the sorting apparatus 100 in which the gap (denoted generally by G) between lower edge portion of the feeding aperture 6 (not on drawing) and the slanted receiving surface 2 (not on drawing) increases from G_{A} to G_{B} and then G_{C}.

FIGS. 5A and 5B are top perspective views of the sorting apparatus 100 shown in FIGS. 4B and 4C.

### DETAILED DESCRIPTION OF PREFERRED EMBODIMENTS

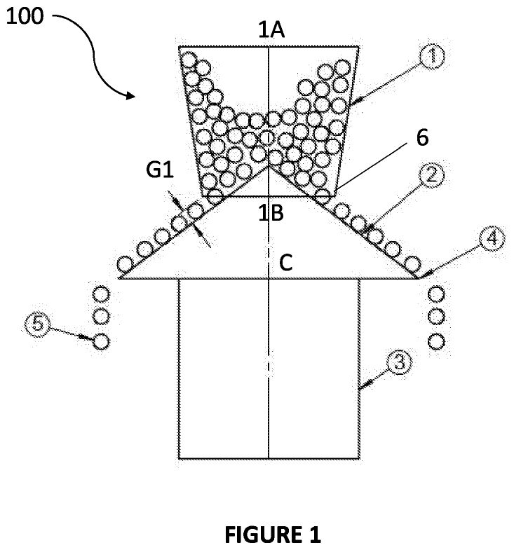

FIGS. 1 to 5 illustrate a sorting apparatus 100 for sorting bulk flowable solids. The apparatus 100 comprises a material feeding chamber 1 with a hollow internal space for receiving and/or holding bulk material. The feeding chamber 1 is frusto-conical in shape and extends between a divergent end 1A and a convergent end 1B. A material feeding aperture 6 is located at the convergent end 1B of the material feeding chamber 1 and is positioned for allowing material particles to flow out of the material feeding chamber under gravity.

It must be noted that the shape and configuration of the material feeding chamber 1 is in not limited to the frusto-conical shape and may be provided in alternative configurations without departing from the invention. By way of example, the feeding chamber 1 may be cylindrical. It must also be noted that the location of the material feeding aperture 6 may be varied. For example, the feeding aperture 6 may be provided separately in spaced apart configuration relative to the feeding chamber 1 in other alternative embodiments.

During use, the bulk flowable solid material may be fed into the feeding chamber 1 from the upper end 1A. Under gravity, the bulk solid materials flow downwards from the divergent end 1A of the feeding chamber 1 to the convergent end 1B of the feeding chamber 1. The material particles flow out of the chamber 1 through the annular aperture 6 onto a slanted receiving surface 2 provided on a conical receiving member C that is positioned on a pedestal or supporting structure 3. It is important to note that a gap, say G1 (See FIG. 1), between the slanted receiving surface 2 and an edge portion of the feed aperture 6 must be sufficiently large (say G1 ie. equal to or greater than the size of the largest particle of the flowable material particles being sorted) to allow the material particles to flow out from the chamber 1 through the aperture 6 and be received on the slanted surface 2. The inclination of the slanted surface 2 causes the received particles to move along the slanted surface 2 of the conical receiving member C under gravity towards the annular edge 4 that is downwardly and outwardly located relative to the aperture 6 of the feeding chamber 1. The received particles fall off the slanted surface 2 to form a substantially vertical flow. As these particles travel past the annular edge 4, they fall off the slanted surface 2 in a vertical direction under the effect of gravity to form a conical pile of the separated particles. The conical pile may have a natural angle of repose attributed to the particle type and particle size being sorted.

In the preferred embodiment, the slanted receiving surface 2 is provided on a cone shaped receiving member C. However, in some alternative embodiments the slanted surface 2 may be provided on a receiving member of any other shape such as a frusto-conical shape.

In a further embodiment, the receiving surface 2 may be replaced by a substantially horizontal surface 20. Initially, flowable material may be allowed to fall on the horizontal receiving surface to form a conical pile of the flowable material particles. The flowable material is deposited on the substantially horizontal surface expands naturally in a substantially conical formation, at the natural angle of repose, up to the bounds of the said substantially horizontal surface. Once the initial pile has been formed, a slanting particle surface extends from the apex of the conical pile towards the bounds of the horizontal receiving surface. Once this pile has been formed, any additional material flowing from the feeding chamber 1 towards the conical pile formation extending up to the annular edge 40 of formed particulate can no longer maintain the natural angle of repose and thus the additional material particles pass the slating particle surface of the formed stationary cone, past the annular edge 40 of the particle formed receiving surface 2 forming a preferably uniform spread of material that is approximately equal to the circumference of the particulate formed conical pile 50.

As shown in FIG. 1, the feed aperture 6 is spaced away from the receiving surface 6 of the cone C by a gap G1 (of at least one average particle size). At the point that the gap between receiving surface 2 and the aperture 6 is just greater than one particle width, material particles will preferably pass under between the feeding aperture 2 and the conical surface 6 to proceed down the cone surface 6 of the standing cone C to the plates bounded edge 4. It is understood by the inventors that depending on the material properties, there is a likelihood of interaction and resulting friction between the passing material particle, the edge of the aperture 6 and the slanted surface 6 of the cone C. Thus, each particle will pass the aperture 6 towards the bounded edge 4 under gravity allowing for the next particle inside the feed aperture 6 to now pass with similar interactions resulting in a slow flow of material. The bounded edge 4 may be provided on an annular plate located at a lower end of the slanted surface 2. The annular plate may extend substantially horizontally relative to the slanted receiving surface 2.

The angle of the slanted receiving surface 2 of the cone C and the width of the gap may be selected such that a sufficient number of collisions occur between the particles and the cone surfaces to remove any kinetic energy the particles may have had before entering the feeding chamber 1. The resulting particle speed at the gap exit of the feed aperture 6 will then be essentially only that resulting from the influence of gravitational force on the particle while in the gap. The angle, curvature and length of the cone C further serve to spread the particles apart so that a monolayer of discrete, non-touching particles results. With these considerations in mind, the cone dimensions and gap width may vary widely, provided only that substantially all of the particles emerging from the gap at the bottom of the feed aperture 6 are falling downward at approximately the angle of the cone and at approximately the same speed. The interaction of particles either side of each particle assists to reduce potential lateral movement of the particle. The arrangement thus acts to render uniform the particle speeds and directions. Of course, the speeds may vary with the mass and shape of the material particles due to the effect of air and surface resistance on free flow.

The gap width between the lower edge portion of the feed aperture 6 and the slanted receiving surface 2 may range for example between 1 to 10 times the major dimension of the largest particle in the mixture, preferably from about 2 to about 5 times. The angle of the delivery cone C may also vary widely, although it will affect the ultimate particle speed. For some particles, best results will be achieved at delivery cone angles between about 30° and about 80°, preferably from about 45° to about 75°, measured with respect to the horizontal. In some embodiments, the length of the slanted surface from the base to the vertex of the cone C may range from about 5 to about 50 times the width of the gap between the lower edge of the feed aperture 6 and the receiving surface 2.

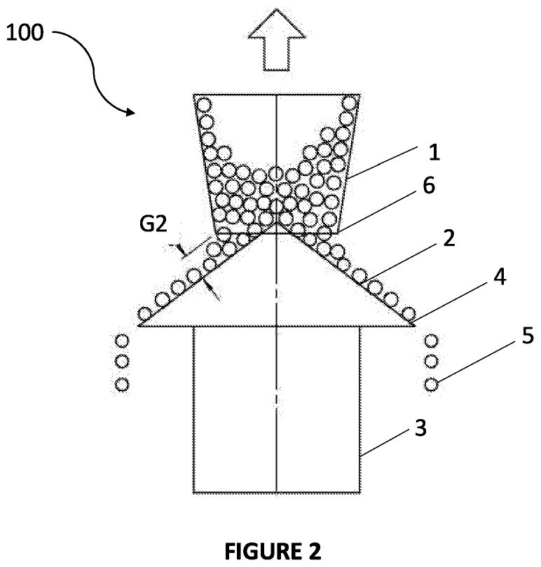

Referring to FIG. 2, the arrow indicates upward movement of the feeding chamber 1 which in turn results in upward movement of the aperture 6. It is understood that the same is achieved by downward movement of the cone C. The upward movement of the aperture relative to the slanted receiving surface 2 results in increasing the gap (to G2) between the edge of the aperture 6 and slanted receiving surface 6. Increasing the gap to G2 (from G1 as shown in FIG. 1) reduces the interaction and friction upon the passing particle under gravity with the standing cone C and the edge of the aperture 6 increasing particle speed and thus enabling the next particle to pass under gravity with similar reduced interactions increasing the flow rate.

To one versed in the art, it is easily seen that, as the aperture 6 moves in a preferably upwards direction, the gap between the aperture bounds and the standing cone increases, particles pass between the cone slated receiving surface 2 and the bounded edge of the aperture 6 more freely under gravity and further increase flow. As the said gap increases to at least two particle widths, then two particles may pass under gravity further increasing capacity. Thus, increasing gap between the aperture 6 and the slanted surface 6 of the cone C increases the capacity of bulk material passed to the point of the maximum flow limited by the feed aperture 6. Conversely it can easily be seen that reducing the gap also reduces the number of particles that may pass between the aperture 6 and the slanted receiving surface 2.

As will be understood by the person skilled in the art, the flow of particles through the feed aperture 6 may be halted by downward movement of the feeding chamber 1 (which in turn results in downward movement of the feed aperture 6) by reducing the gap between the edge of the aperture 6 and the receiving surface 2 to less than the size of the larger particles being sorted. As the larger particles no longer have the room to pass between the slanted receiving surface 2 and edge of the aperture 6, the particles behind will block and will cease to flow.

Another advantage of the presently described invention is that the apparatus 100 allows the formation of a monolayer of uniformly spread material particles even under differing flow rates of the particles exiting the feed aperture 6. For example, even if the gap between the slanted receiving surface 2 and the edge of the feed aperture 6 is increased to two times of the average particle size of the particle being sorted, the particle flow rate increases but continues to form a monolayer of uniformly spread material particles because the particles exiting the feed aperture 6 are substantially passing through under gravity and no other force. As a result, each material particle falls under gravity towards the slanted surface 2 of the standing cone C.

The sorting process may be made continuous by allowing material particles to continuously flow out of the aperture 6 towards the slanted receiving surface 2 of the cone member C. The material particles in the internal volume of the feeding aperture 6 that are positioned closest to the slanted surface 2 will fall first on the slanted surface 2 and leave the rest of the particles riding on top. Each material particle that falls onto the slanted surface 2 moves downwards under the effect of gravity to the slanted surface 2 to naturally spread providing gaps for those on top to move onto an upper portion of the slanted surface 2 of the cone C and become part of the substantially monolayer flow. The limiting capacity of a cone to produce a uniform monolayer or uniform layer of material at a desired thickness is based on the number of particles able to fit in the circumference of the cone base at the bounded edge of the slanted surface 2 and the speed at which they pass the bounded edge.

In the preferred embodiment the standing cone C and the slanted receiving surface 2 may be formed from materials as the bulk feed material being sorted. In other embodiments, the slanted surface 2 and the cone member be formed from other materials which may be the likes of cast or formed metals or plastics or from other particulate of dissimilar size or material type. Further, the angle of inclination of the slanted surface 2 may not be similar to the feed material's angle of repose. Further embodiments may be a mixture of materials and angles to provide the optimal response of uniform feed. A preformed cone may still require a bounded edge at the base to pass the uniform flow. A substantially horizontal annular plate bounded by an edge may not be required in some embodiments.

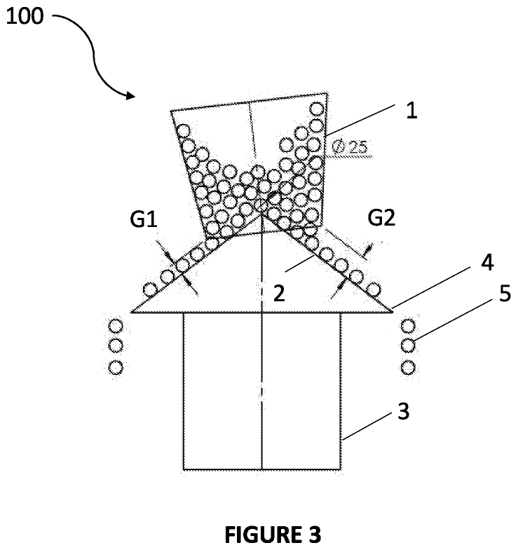

Referring to FIG. 3, the feeding chamber 1 and the feed aperture 6 may be tilted or moved laterally to allow variation in the gap between the lower edge of the feed aperture 6 and the slanted surface 2. Upon tilting the feeding chamber 1, the annular gap between the lower edge of the feed aperture 6 and slanted surface 2 becomes non-uniform as indicated by a first gap G1 at one end of the annular gap and a second gap G2 at another end of the annular gap such that G2 is greater than G1.

The feed aperture 6 may be tilted or moved laterally to a non-coaxial z(non-concentric) configuration relative to the cone C to compensate for minor flow or uniformity variations in the feed response of the material passing the annular plates bounded edge. In further embodiments, the feed aperture 6 may be constricted or dilated to change the gap between the edge of the feed aperture 6 and the receiving surface 2 of the cone C thereby providing flow control. Similarly, in further embodiments, the dimensions of the cone C may also be varied by constricting or dilating the standing cone C. In embodiments where the standing cone C is made from the same material as the bulk feed material, the substantially horizontal annular edge bounded plate may be constricted or dilated.

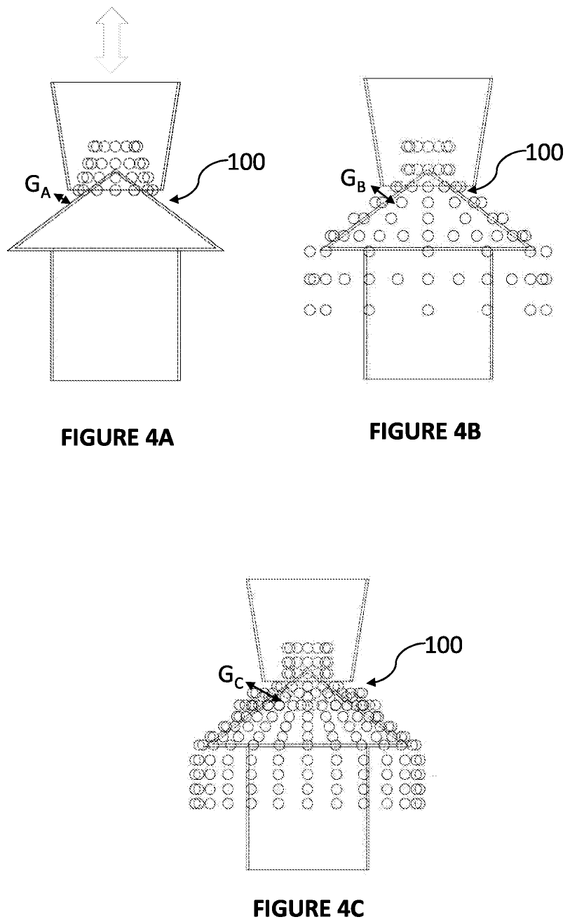

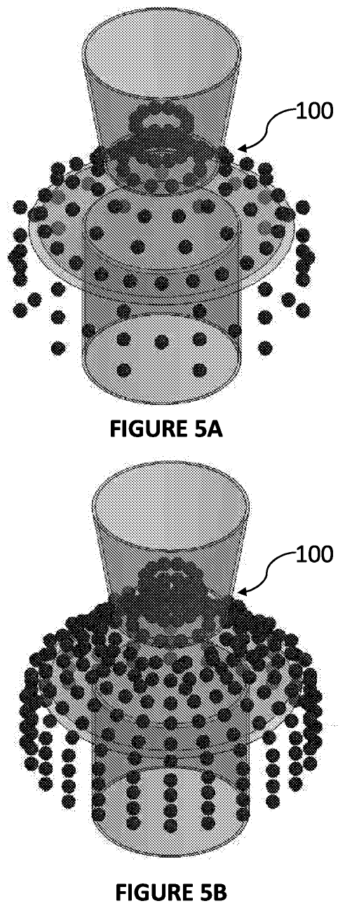

FIGS. 4A to 4C illustrate the sequential movement of the feeding chamber 1 and the feed aperture 6. In an initial position (shown in FIG. 4A), the gap A between the lower edge of the feed aperture 6 and the slanted receiving surface 2 is smaller the larger particle size of the particles being sorted. As a result, there is no outward and downward flow of particles from the feed aperture 6. In FIG. 4B, the feeding chamber 1 and feeding aperture 6 are moved in an upwardly direction to increase the gap between the lower edge of the feed aperture 6 and the slanted receiving surface to G_{B} whereby G_{B} is substantially similar to the larger particle size of the particle being sorted. As shown in FIG. 4C, the feeding chamber 1 may be moved upwards to further increase the gap to G c resulting in an increase in the overall flow rate of the material particles flowing out of the feed aperture 6. As explained in the earlier sections, an increase in the gap from G_{B} to G_{C} does not affect the monolayer formation of the sorted particles. FIGS. 5A and 5B illustrate top perspective views of the apparatus shown in FIGS. 4B and 4C.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. Sorting apparatus for sorting of bulk material comprising flowable particles, the apparatus comprising:
a material feeding chamber for receiving and/or holding bulk material;
a feeding aperture positioned relative to the chamber for allowing material particles to flow out of the material feeding chamber under gravity;
a slanted receiving surface positioned below the feeding chamber and spaced away from an edge portion defining the feeding aperture by a gap to receive the material particles flowing out from the feeding aperture, the gap being the shortest distance between the edge portion defining the feeding aperture and the slanted surface;
wherein the gap between the edge portion defining the feeding aperture and the slanted surface is at least equal to the average particle size of the flowable material particles being sorted.

2. Sorting apparatus in accordance with claim 1 further comprising spacing arrangement for controlling a size of the gap between the edge portion of the feeding aperture and the slanted surface.

3. Sorting apparatus in accordance with claim 1 wherein the slanted surface and/or the feeding aperture are movably mounted for controlling a size of the gap between the edge portion of the feeding aperture and the slanted surface.

4. Sorting apparatus in accordance with claim 1 wherein the feeding aperture is defined by edge portions of one or more internal walls defining the material feeding chamber.

5. Sorting apparatus in accordance with claim 1 wherein the material feeding chamber comprises a hollow frusto-conical chamber extending between a first end and a second end with an internal space for receiving the bulk material to be sorted.

6. Sorting apparatus in accordance with claim 5 wherein the feeding aperture is positioned at one of said first or second ends, the sorting apparatus further comprising one or more convergent internal walls defining the hollow internal space wherein the convergent internal wall converges in a direction from the first end to the second end and wherein the feeding aperture is located at or adjacent the second end.

7. (canceled)

8. Sorting apparatus in accordance with claim 1 further comprises a substantially conical or frusto-conical receiving body having said slanted receiving surface.

9. Sorting apparatus in accordance with claim 8 wherein the convergent upper portion of the conical or frusto-conical receiving body is received into the feeding aperture such that the gap between the edge portion of the feeding aperture and the slanted surface of the conical or frusto-conical receiving body is at least equal to a larger particle size of the flowable material particles being sorted.

10. Sorting apparatus in accordance with claim 8 wherein during use, the edge portion defining the aperture is spaced away from the slanted surface of the receiving body to define an annular gap therebetween for controlling the flow of the material particles flowing out of the aperture under gravity.

11. Sorting apparatus in accordance with claim 10 wherein separation between the slanted surface and the edge portion of the aperture is substantially uniform along the entire length of the annular gap.

12. Sorting apparatus in accordance with claim 10 wherein separation between the slanted surface and the edge portion of the aperture is substantially non-uniform along the entire length of the annular gap.

13. Sorting apparatus in accordance with claim 8 further comprising a first positioning arrangement to position and retain the chamber and the conical or frusto-conical receiving body coaxially relative to each other.

14. Sorting apparatus in accordance with claim 8 further comprising a second positioning arrangement to position and retain the chamber and the conical or frusto-conical receiving body in a non-coaxial configuration relative to each other.

15. Sorting apparatus in accordance with claim 8 wherein apex angle of the receiving body is greater than apex angle of the frusto-conical chamber.

16. Sorting apparatus in accordance with claim 1 wherein the slanted surface is formed by collecting material particles on a substantially flat collecting surface to form a pile, the slanted surface being formed by the collected particles of the pile at an angle of repose to an edge portion of the collecting surface thereby forming a slanted particle surface at the angle of repose positioned to form the gap with the edge portion defining the aperture of the chamber and wherein the slanted particle surface receives and diverts the material particles flowing out from the feeding aperture to form a monolayer of said material particles upon passing the collecting surface bounded edge.

17. Sorting apparatus in accordance with claim 1 wherein the size of the feed aperture is variable and wherein the apparatus further comprises a controller for controlling size of the feed aperture is variable.

18. Sorting apparatus in accordance with claim 1 wherein the gap between the edge portion of the feeding aperture and the slanted surface is no greater than a value X, wherein X is less than 10 times the average particle size of the flowable material particles being sorted.

19. Sorting apparatus in accordance with claim 1 wherein the feed aperture is movable in an upward or downward vertical direction relative to the slanted surface to vary the size of the gap between the edge of the aperture and the slanted surface.

20. Sorting apparatus in accordance with claim 1 further comprising deflecting members positioned at or adjacent said apertures for deflecting material particles onto the slanted surface.

21. A method for sorting of bulk material comprising flowable particles, the method comprising:
directing said bulk flowable material into a feeding chamber positioned for receiving and/or holding bulk material;
positioning a feeding aperture relative to the chamber to allow material particles to flow out of the feeding aperture under gravity onto a slanted receiving surface positioned below the feeding chamber and spaced away from an edge portion defining the feeding aperture by maintaining a gap between the edge portion of the feeding aperture and the slanted surface such that the gap is at least equal to the average particle size of the flowable material particles being sorted.

22-35. (canceled)
